(19) United States
(12) Patent Application Publication
(10) Pub. No.: US 2009/0280229 A1
(43) Pub. Date: Nov. 12, 2009

(54) METHOD AND APPARATUS FOR MANUFACTURING PROTEIN BEVERAGES

(76) Inventors: Wendy L. Constantine, Weston, CT (US); Martin L. Cressman, Shortsville, NY (US); John Eaton, Oxford, CT (US); Eric A. Gold, Frisco, TX (US); Harish N. Golwala, Frisco, TX (US); Witold Rossochacki, McKinney, TX (US); Margaret W. Varhol, Prospect, CT (US)

Correspondence Address: COX SMITH MATTHEWS INCORPORATED, 112 EAST PECAN STREET, SUITE 1800, SAN ANTONIO, TX, 78205-1521, US

(21) Appl. No.: 12/116,837

(22) Filed: May 7, 2008

(51) Int. Cl. A23L 3/16; B65B 55/14

(52) U.S. Cl. 426/521; 426/397

(57) ABSTRACT

An apparatus for hot filling containers with protein beverage may comprise a batch tank adapted for receiving a protein beverage, a first heat exchanger adapted for heating the protein beverage to a pasteurizing temperature, a reservoir adapted for receiving the protein beverage and having an overflow stream of the protein beverage, a filler adapted for at least partially filling containers with the protein beverage, a second heat exchanger adapted for cooling the overflow stream, a rework tank adapted for receiving the overflow stream, and a control valve adapted for controlling a percentage of the overflow stream recycled to the first heat exchanger from the rework tank such that the protein beverage remains substantially free of floc. A method for making a protein beverage substantially free of floc is also described.

### FIELD

This application relates generally to protein beverages and apparatuses and methods for manufacturing the same.

### BACKGROUND

Protein beverages have become increasingly popular with consumers due to the efficacy of such beverages in aiding athletic performance, promoting satiety and weight loss, and for various other health benefits. These beverages have become especially popular with athletes since protein may be added to a source of carbohydrates, as described in U.S. Pat. No. 6,207,638, to provide increased insulin stimulation and muscle glycogen synthesis with no negative impact on rehydration following exercise. Indeed, as described in U.S. Pat. No. 6,989,171, the addition of protein to a beverage increases the energy efficiency of carbohydrates in the beverage and improves athletic endurance.

Protein beverages may contain a variety of suitable proteins derived from plant, dairy, and/or other animal protein sources. Examples of suitable proteins include casein; whey proteins, such as β-lactoglobulins and α-lactalbumins, and bovine serum albumins; egg proteins, such as ovalbumins; and soy proteins, such as glycinin and conglycinin. The exact composition of a whey protein mixture will vary depending on geography, season, animal breed, and processing. However, a typical whey protein mixture may comprise about 50% by weight β-lactoglobulin and about 25% by weight α-lactalbumin as the dominant proteins. See D. G. Dalgliesh, Milk Proteins Chemistry and Physics in Food Proteins, P. F. Fox and J. J. Condon (Eds.), Springer, 1982, pp. 155 et. seq.

In order to prolong shelf life and satisfy various regulatory regimes relating to consumable beverages, protein beverages may be pasteurized to minimize or negate microbial activity. The heating of a protein beverage, as occurs during pasteurization, has a tendency to denature the protein. The process of denaturation occurs when the conformation of a protein in its native, undenatured state is changed to a more disordered arrangement. Protein conformation is the characteristic three-dimensional shape of a protein, imposed upon it by the secondary and tertiary structure of the peptide chain.

The chemical processes involved in denaturation can be complex, though they often involve modification in the secondary, tertiary or quaternary conformation of the protein without the rupture of peptide bonds involved in the primary structure. Denaturation may involve the entire protein molecule, or may be confined to a particular region of the protein. A denatured protein may exhibit a decrease in solubility due to exposure of hydrophobic groups, changes in water binding capacity, and increased susceptibility to enzymatic attack.

Denatured proteins have a tendency to aggregate due to intermolecular interactions, thereby causing flocculation in the protein beverage. See M. T. A. Evans and J. F. Gordon, Whey Proteins in Applied Protein Chemistry, R. A. Grant (Ed), Applied Science Publishers, 1980, p. 36. Flocculation is undesirable as it may cause fouling of process equipment and may result in protein beverages containing floc. Consumers may decide not to purchase protein beverages containing floc, as these beverages have a “clumpy” and/or “murky” appearance.

### SUMMARY

An apparatus for hot filling containers with protein beverage may comprise a batch tank adapted for receiving a protein beverage, a first heat exchanger adapted for heating the protein beverage to a pasteurizing temperature, a reservoir adapted for receiving the protein beverage and having an overflow stream of the protein beverage, a filler adapted for at least partially filling containers with the protein beverage, a second heat exchanger adapted for cooling the overflow stream, a rework tank adapted for receiving the overflow stream, and a control valve adapted for controlling a percentage of the overflow stream recycled to the first heat exchanger from the rework tank such that the protein beverage remains substantially free of floc. A method for making a protein beverage substantially free of floc is also described.

### BRIEF DESCRIPTION OF THE DRAWINGS

FIG. 1 is a graph depicting plots of native protein content in a protein beverage versus hold time and temperature.

FIG. 2 is a graph depicting plots of denatured protein content in a protein beverage versus hold time and temperature.

FIG. 3 is a graph depicting plots of percent flocculant in a protein beverage versus hold time and percent seed.

FIG. 4 is a schematic diagram illustrating an apparatus and process for manufacturing a pasteurized protein beverage.

### DETAILED DESCRIPTION

As used herein, the following terms should be understood to have the indicated meanings:

When an item is introduced by “a” or “an,” it should be understood to mean one or more of that item.

The terms “first,” “second,” and the like as used herein do not denote any order, quantity, or importance, but rather are used to distinguish one element from another.

“Comprises” means includes but is not limited to.

“Comprising” means including but not limited to.

“Having” means including but not limited to.

“Beverage” means any drinkable liquid or semi-liquid, including for example and without limitation, flavored water, soft drinks, fruit drinks, coffee-based drinks, tea-based drinks, juice-based drinks, milk-based drinks, gel drinks, carbonated or non-carbonated drinks, alcoholic or non-alcoholic drinks.

“Protein” means protein from any source, including but not limited to plant, dairy, animal, synthetic, or any other suitable protein source. Examples of protein include but are not limited to casein; whey proteins, such as β-lactoglobulins and α-lactalbumins, and bovine serum albumins; egg proteins, such as ovalbumins; and soy proteins, such as glycinin and conglycinin.

“Protein beverage” means a beverage which contains one or more proteins.

“Soluble” means the characteristic of a substance whereby it is not visible to the unaided eye when added to a solvent.

“Insoluble” means the characteristic of a substance whereby it is visible to the unaided eye when added to a solvent.

“Floc” means insoluble protein within a protein beverage.

“Flocculation” means the process of floc formation.

“Seed” means protein beverage which has been pasteurized at least once. Protein beverage which is recycled in a bottling process after being pasteurized is seed.

“Inhibit” means to at least partially decrease the presence of floc.

“Acid components” means food-grade acids such as, for example and without limitation, acetic acid, adipic acid, ascorbic acid, butyric acid, citric acid, formic acid, fumaric acid, glyconic acid, lactic acid, malic acid, phosphoric acid, oxalic acid, succinic acid, and tartaric acid.

“Hot-filling” means a method of sterilizing a container by filling it with a heated beverage having a temperature sufficient for sterilization.

“Added water” means water added to a beverage as a component, and does not mean water incidentally added to a beverage through other components.

“Dry composition” means the composition of a beverage without taking into account any added water.

“Liquid communication” means, with respect to a first element and a second element, a condition in which liquid is passable from one element to the other, either directly or through one or more intermediate elements.

“Liquid composition” means the composition of a beverage including any added water.

“Fouling” means a characteristic of a flow stream whereby its flow is disrupted by a sufficiently high concentration of floc.

“Hold time” means the amount of time at which a protein beverage is held at a temperature sufficient to cause pasteurization.

The endpoints of all ranges directed to the same component or property are inclusive and independently combinable.

U.S. Pat. No. 6,051,236 is herein incorporated by reference.

U.S. Pat. No. 6,989,171 is herein incorporated by reference

U.S. patent application Ser. No. 11/336,678 filed Jan. 20, 2006, in the name of Robert Portman for “Sports Drink Composition for Enhancing Glucose Uptake into the Muscle and Extending Endurance During Physical Exercise,” is herein incorporated by reference.

U.S. patent application Ser. No. 11/337,414 filed Jan. 23, 2006, in the name of Robert Portman for “Sports Drink Composition for Enhancing Glucose Uptake into the Muscle and Extending Endurance During Physical Exercise,” is herein incorporated by reference.

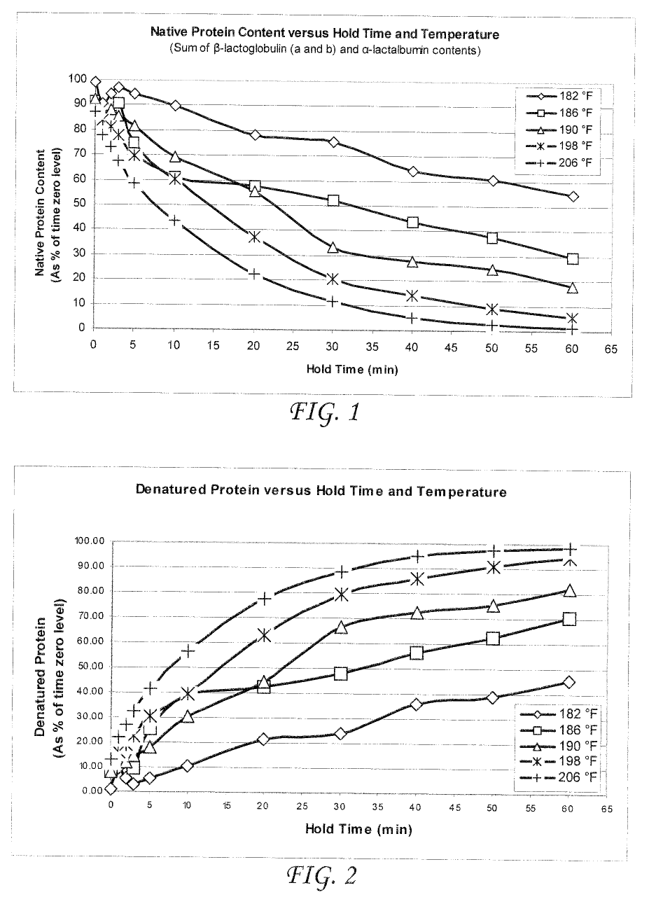

Referring to FIG. 1, a protein beverage was prepared having a liquid composition comprising about 1.58% by weight whey protein isolate. The protein beverage had a Brix reading of about 8.7° Bx at 68° F., and the pH of the protein beverage was about 3.3 at 68° F. Multiple samples of the protein beverage were pasteurized at various pasteurization temperatures, ranging from about 182° F. to about 206° F., using a MicroThermics MiniProduction™ pasteurizer (MicroThermics, Inc., Raleigh, N.C.). The temperature of the pasteurized samples was maintained at the pasteurization temperature using thermostatted hot water baths for about one hour. The samples were tested periodically to determine the amount of native, undenatured β-lactoglobulin and α-lactalbumin proteins remaining, using the method described by N. Parris and M. A. Baginski. See N. Parris and M. A. Baginski, A Rapid Method for the Determination of Whey Protein Denaturation, J. Dairy Sci., vol. 74, 1990, pp. 58-64.

FIG. 1 depicts the amount of native, undenatured protein remaining in a pasteurized protein beverage as a function of both pasteurization temperature and hold time. This graph suggests that the amount of native, undenatured protein decreases with both increasing pasteurization temperature and hold time. It is reasonable to assume that this “lost” native, undenatured protein is still present in the protein beverage, but in a denatured state. Consequently, FIG. 2 depicts essentially the inverse of FIG. 1, or the amount of denatured protein present in the pasteurized protein beverage. Both FIGS. 1 and 2 suggest that increases in either pasteurization temperature or hold time have a tendency to increase the amount of denatured protein in the beverage.

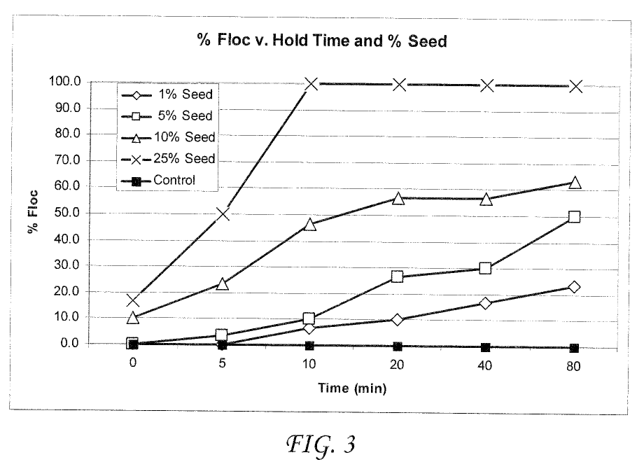

Referring now to FIG. 3, a protein beverage was prepared as described above, except that the beverage was pasteurized at a pasteurizing temperature of 195° F. using a MicroThermics MiniProduction™ pasteurizer. Other suitable pasteurizing temperatures may be used, depending on the particular application. The seed was then added to non-pasteurized protein beverage so as to create four different samples having seed concentrations of about 1%, about 5%, about 10%, and about 25% by weight, respectively. An additional control sample containing only non-pasteurized protein beverage was also prepared. The samples were placed in 40 mL EPA glass vials and allowed to cool at ambient temperature. The samples were tested periodically to determine the amount of floc present, measured as millimeters of floc from the bottom of the glass vial to top of the visible floc “clump.” The percent of floc was determined by dividing the millimeters of floc by the total height of the sample in the glass vial (30 millimeters).

FIG. 3 depicts the percent of floc in a protein beverage as a function of both percent seed and hold time. This graph suggests that the amount of floc increases with both increasing percent seed and hold time. The control sample did not exhibit any floc, suggesting that flocculation is surprisingly sensitive to the presence of seed. It is believed that this sensitivity may result from molecular interactions within the seed which stabilize floc and increase the likelihood that proteins in the protein beverage may become insoluble.

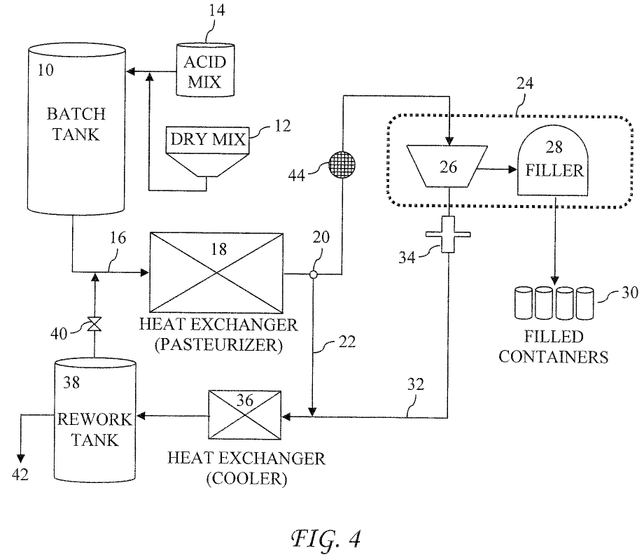

The present application is directed to a method and apparatus for manufacturing pasteurized protein beverages which are substantially free of floc. In one embodiment, a method by which such protein beverages may be made is illustrated by reference to the apparatus of FIG. 4.

Referring to FIG. 4, a non-pasteurized protein beverage may be stored in a batch tank 10 before pasteurization and bottling. The non-pasteurized protein beverage may be formed from its constituent components inside the batch tank 10, or may be formed elsewhere prior to storage in the batch tank 10. If the non-pasteurized protein beverage is formed in the batch tank 10, one or more dry components of the protein beverage may be blended separately in a dry mixer 12 before being added to the batch tank 10. Similarly, one or more acid components of the protein beverage may be blended separately in an acid mixer 14 before being added to the batch tank 10. Separate mixing of the dry components and the acid components may reduce the amount of foaming of the protein beverage. Foaming protein beverage has a tendency to stagnate as it floats on top of non-foaming protein beverage, and therefore it is more prone to flocculation. Consequently, a reduction in foaming of the protein beverage serves to inhibit flocculation.

The non-pasteurized protein beverage is passed by flow line 16 to a first heat exchanger 18 for pasteurization. The first heat exchanger 18 may be a plate heat exchanger composed of multiple plates in parallel having fluid flow passages containing a heated liquid medium which is not in direct contact with the protein beverage but is separated by equipment contact surfaces. The large surface area of the plates facilitates thermal exchange between the heated liquid medium and the protein beverage and allows for a substantially uniform heating of the protein beverage. Of course, any other type of suitable heat exchanger may be used. In the first heat exchanger 18, the beverage is heated to a pasteurizing temperature in the range of about 178° F. to about 200° F. In one embodiment, the temperature of pasteurized protein beverage exiting the first heat exchanger 18 may be about 189° F. Of course, other pasteurizing temperatures may be used, depending on the particular application.

The process of pasteurization is a function of both time and temperature, and may be described by reference to the total heat contributed to the protein beverage, as measured in Pasteurization Units (PUs). In one embodiment, the protein beverage may be sufficiently pasteurized upon application of about 5021 PUs. The greater the total heat contributed to the protein beverage, the more likely flocculation will occur. In one embodiment, the heat exchanger 18 may be operated so as to minimize the total heat contributed to the protein beverage while still applying a sufficient number of PUs to pasteurize the protein beverage, thereby inhibiting flocculation.

The output of the first heat exchanger 18 passes through a divert valve 20, which may operate to divert protein beverage exiting the first heat exchanger 18 into flow line 22. Protein beverage is typically diverted into flow line 22 if it does not reach a certain set point temperature during the pasteurization process. Pasteurized protein beverage which is not diverted into flow line 22 passes on to a filler assembly 24, possibly through a flow filter 44 as discussed further below. The filler assembly 24 comprises of a reservoir 26 adapted for receiving the pasteurized protein beverage, and a filler 28 adapted for hot-filling containers 30 with a main stream of the pasteurized protein beverage from the reservoir 26. A person having ordinary skill in the art will understand that the orientation of the reservoir 26 and filler 28 within the filler assembly 24 may vary depending upon the overall process configuration and equipment used. For example, the reservoir 26 and filler 28 may be combinable to form a single piece of equipment.

The filler 28 may be a pressure gravity type filler, such as a KHS Innofill™ series pressure gravity type filler (KHS USA, Inc., Waukesha, Wisc.). In one embodiment, the filler 28 comprises one or more injectors in fluid communication with the reservoir 26 and may or may not comprise a circulating filler loop in fluid communication with the one or more injectors. The one or more injectors may also comprise one or more calibrated electrode sensors adapted for dispensing a set amount of pasteurized protein beverage. Pasteurized protein beverage inside a circulating filler loop has a tendency to stagnate. Consequently, use of a filler 28 which does not comprise a circulating filler loop generally serves to inhibit flocculation. A person having ordinary skill in the art will understand that other suitable types of fillers may be used such as, for example, gravity type fillers, vacuum type fillers, flow measurement fillers, mass measurement fillers, electronic weigh scale fillers, and piston fillers.

The containers 30 may comprise various materials, including but not limited to glass bottles; plastic bottles and containers such as polyethylene terephthalate (PET) or foil lined ethylene vinyl alcohol; metal cans such as coated aluminum or steel; and lined cardboard containers and cartons. Other packaging material known to one of ordinary skill in the art may also be used. In one embodiment, the containers 30 may be PET bottles adapted for receiving pasteurized protein beverage heated to a temperature of about 185° F. After the containers 30 are hot-filled with pasteurized protein beverage, they may be cooled using various cooling processes known to persons having ordinary skill in the art. After cooling, the containers 30 may be processed further by, for example, labeling, packaging, storing, and shipping the containers 30.

Still referring to FIG. 4, in order to keep the filler 28 supplied with sufficient pasteurized protein beverage during the filling process, a surplus of pasteurized protein beverage may be supplied to the reservoir 26. The surplus of pasteurized protein beverage also serves to maintain a pressure differential between pasteurized and non-pasteurized protein beverage, which ensures a proper directional flow and prevents contamination of the pasteurized protein beverage. Surplus protein beverage which does not fill the containers 30 (sometimes referred to herein as an overflow stream) is passed to flow line 32, possibly through a trim cooler 34 as described further below. During the bottling process, typically less than about 15% of the pasteurized protein beverage entering the reservoir 26 is passed to flow line 32 as an overflow stream. In one embodiment, about 10% of the pasteurized protein beverage entering the reservoir 26 is passed to flow line 32. Of course, other suitable percentages of pasteurized protein beverage may be passed to flow line 32, depending on the particular system design. However, when the bottling process is interrupted, as when the filler assembly malfunctions or suffers a momentary stoppage, a much larger percentage of the pasteurized protein beverage entering the reservoir 26 may be passed to flow line 32, typically more than about 85%.

In one embodiment, a trim cooler 34 may be placed along flow line 32 near the exit of the reservoir 26 for purposes of cooling the surplus protein beverage before it reaches the second heat exchanger 36. While the cooling capacity of the trim cooler 34 may be insufficient to significantly cool a large volume of surplus protein beverage, as occurs during interruption of the bottling process, the trim cooler 34 may be used to cool a smaller volume of surplus protein beverage, as occurs during the normal bottling process. The smaller the volume of surplus protein beverage passed to flow line 32, the longer it takes the surplus protein beverage to reach the second heat exchanger 36. Consequently, a smaller volume of surplus protein beverage remains heated for a longer period of time than a larger volume of surplus protein beverage, which tends to encourage flocculation. Therefore, the trim cooler 34 cools the smaller volume of surplus protein beverage and serves to inhibit flocculation during the normal bottling process. In one embodiment, a trim cooler 34 may be a double-tube type trim cooler. Of course, other suitable coolers may also be used.

The surplus protein beverage in flow line 32 may be combined with the diverted protein beverage in flow line 22 as it enters a second heat exchanger 36 for cooling. The second heat exchanger 36 may be a plate heat exchanger capable of cooling the surplus protein beverage and diverted protein beverage to a temperature less than about 140° F. In one embodiment, the temperature of pasteurized protein beverage exiting the second heat exchanger 36 may be about 100° F. A person having ordinary skill in the art will understand that other suitable heat exchanger types may be used to pasteurize and cool the protein beverage, including, by way of example, shell and tube heat exchangers, regenerative heat exchangers, adiabatic wheel heat exchangers, fluid heat exchangers, and dynamic surface heat exchangers.

Channeling within a heat exchanger may occur when the flow rate design capacity of the heat exchanger is greater than the actual process flow rate. Channeling may result in beverage stagnation, uneven heat transfer, and temperature spikes, which tend to cause flocculation. In one embodiment, the first and second heat exchangers 18, 36 may be adapted for receiving flow rates of protein beverage such that channeling is minimized or avoided, thereby inhibiting flocculation.

The cooled protein beverage exiting the second heat exchanger 36 is passed to a rework tank 38 for temporary storage. A flow control valve 40 may be operated so as to recycle a portion of the cooled protein beverage back into flow line 16. If the volume of cooled protein beverage in the rework tank 38 exceeds the capacity of the rework tank 38, the excess protein beverage may be passed to a drain 42 for removal. If the recycled portion of cooled protein beverage is too large, floc will begin to form in the pasteurized protein beverage. The onset of floc formation may be monitored through placement of a flow filter 44 at any point in the process. In one embodiment, flow filter 44 may be placed near the exit of the first heat exchanger 18 and may be a 100 mesh filter having a mesh spacing of about 140 microns. Flow filter 44 may comprise a pressure sensor adapted for measuring pressure differentials across flow filter 44. Of course, any suitable filter may be used and a person having ordinary skill in the art will understand that flow filter 44 may be placed anywhere along the process flow stream. Additionally, more than one flow filter 44 may be used.

The flow control valve 40 may be operated so as to pass an initial recycled portion of cooled protein beverage from rework tank 38. If flow filter 44 remains substantially free of floc upon visual inspection and/or the pressure differential across the flow filter 44 remains unchanged or not significantly changed from its initial reading at the start of the bottling process, the recycled portion of cooled protein beverage may be increased. Alternatively, if the flow filter 44 contains floc upon visual inspection and/or the pressure differential across the flow filter 44 increases significantly from its initial reading at the start of the bottling process, the recycled portion of cooled protein beverage may be decreased or halted. By using this iterative adjustment process, flow control valve 40 may be operated so as to pass the maximum permissible amount of recycled portion of cooled protein beverage in the flow line 16 while sufficiently inhibiting flocculation. A person having ordinary skill in the art will understand that flow filter 44 may be effective in filtering a certain amount of floc from the process, thereby allowing the recycled portion of cooled protein beverage from rework tank 38 to be increased. Consequently, flow control valve 40 may be operated so as to pass the maximum permissible amount of recycled portion of cooled protein beverage in the flow line 16 while sufficiently minimizing or preventing fouling.

A person having ordinary skill in the art will understand that the onset of floc formation may be monitored using other known methods, such as, by way of example, visual inspection of the containers 30 and optical measurement of the flow filter 44 and/or containers 30 by electronic means.

Persons of ordinary skill in the art will also recognize that suitable pumps, valves, and other liquid processing equipment may be used at various points in the system to direct and transport the protein beverage through the system as may be desirable depending on the particular application.

All patents, patent applications, and other references identified by number herein are incorporated herein by reference in their entirety.

Embodiments of the invention will be further described in connection with the following examples, which are set forth for purposes of illustration only:

### EXAMPLE 1

A non-pasteurized protein beverage was prepared in a 3000 gallon stainless steel batch tank with a mixer. More particularly, a non-pasteurized beverage was prepared having the following dry composition:

Dry Composition of Protein Beverage

| Component | % by Weight |
|---|---|
| Trehalose (disaccharide) | 19.33% |
| Whey protein isolate (protein) | 15.99% |
| Natural flavors | 2.63% |
| Medium Invert Sugar (aqueous solution of | 53.43% |
| sucrose/fructose/glucose) | |
| Sodium chloride (electrolyte) | 0.911% |
| Magnesium carbonate (electrolyte) | 1.012% |
| Sodium ascorbate (vitamin C) | 0.006% |
| Vitamin E acetate (vitamin E) | 0.064% |
| Citric acid, phosphoric acid, lactic acid | 6.27% |
| Monopotassium phosphate (electrolyte) | 0.212% |
| Red 40 (coloring) | 0.152% |

The whey protein was admixed in a tri-blender before being added to the batch tank. The acid components were admixed in a separate 1000 gallon batch tank before being added to the larger batch tank. Additionally, about 2700 gallons of added water was furnished to the larger batch tank, resulting in the following liquid composition:

Liquid Composition of Protein Beverage

| Component | % by Weight |
|---|---|
| Trehalose (disaccharide) | 1.91% |
| Whey protein isolate (protein) | 1.58% |
| Natural flavors | 0.26% |
| Medium Invert Sugar (aqueous solution of | 5.28% |
| sucrose/fructose/glucose) | |
| Sodium chloride (electrolyte) | 0.09% |
| Magnesium carbonate (electrolyte) | 0.10% |
| Sodium ascorbate (vitamin C) | 0.0006% |
| Vitamin E acetate (vitamin E) | 0.0063% |
| Citric acid, phosphoric acid, lactic acid | 0.62% |
| Monopotassium phosphate (electrolyte) | 0.021% |
| Red 40 (coloring) | 0.015% |
| Added water | 90.12% |

The non-pasteurized protein beverage had a Brix reading of about 8.7° Bx at 68° F., and the pH of the protein beverage was about 3.3 at 68° F., as measured using a Metrohm LL™ combined pH penetration electrode (Metrohm Ltd., Switzerland). The titratable acidity (TA) of the beverage, expressed as anhydrous citric acid using 0.1N sodium hydroxide titration, was about 0.51 g per 100 mL. The non-pasteurized beverage also had a protein concentration of about 9 g per 591 mL.

The protein beverage was first passed through a plate heat exchanger having a flow capacity of about 43 gallons per minute. The temperature of the protein beverage as it exited the plate heat exchanger was about 189° F.

Next, the pasteurized protein beverage was passed to a KHS Innofill™ series pressure gravity type filler, which comprised one or more injectors in fluid communication with a reservoir and which did not comprise a circulating filler loop in fluid communication with the one or more injectors. The injectors comprised a calibrated electrode sensor to dispense pasteurized protein beverage into 20 oz. PET bottles. The residence time of the pasteurized protein beverage from the outlet of the first heat exchanger to the filler assembly was about 95 seconds, and the temperature of the beverage as it entered the PET bottles was about 182° F.

The surplus protein beverage was passed to a second plate heat exchanger having a flow capacity of about 5 gallons per minute. The temperature of the surplus protein beverage as it exited the second plate heat exchanger was about 100° F. The cooled protein beverage was then passed to a 1000 gallon rework tank having a control valve for controlling the amount of cooled protein beverage recycled back to the pasteurizer. Mesh-type 100 filters having a mesh spacing of about 140 microns were installed before and after the pasteurizer and comprised pressure sensors adapted for measuring pressure differentials across the filter. Operators monitored readings from the pressure sensors and conducted visual inspections of the filters for signs of flocculation.

The control valve was operated so as to recycle about 10% of the cooled protein beverage. With a recycle rate of about 10%, the filters showed some signs of flocculation, but not enough to cause fouling. Consequently, the recycle rate was not decreased.

### EXAMPLE 2

A non-pasteurized protein beverage was prepared as in EXAMPLE 1, except as noted below. The protein beverage was prepared in a 4000 gallon stainless steel batch tank with a mixer. The acid components were admixed in a separate 800 gallon batch tank before being added to the larger batch tank. The protein beverage was first passed through a plate heat exchanger having a flow capacity of about 50 gallons per minute. The temperature of the protein beverage as it exited the plate heat exchanger was about 189° F.

Next, the pasteurized protein beverage was passed to a Linker™ FC 72-20 pressure gravity type filler (Linker Equipment Corp., Hillside, N.J.), which comprised one or more injectors in fluid communication with a reservoir and a circulating filler loop in fluid communication with the one or more injectors. The filler was adapted for filling 20 oz. PET bottles with pasteurized protein beverage. The residence time of the pasteurized protein beverage from the outlet of the pasteurizer to the filler assembly was about 128 seconds, and the temperature of the beverage as it entered the PET bottles was about 180° F.

The surplus protein beverage was passed to a second plate heat exchanger, where it was cooled to a temperature of about 90° F. The cooled protein beverage was then passed to a 900 gallon rework tank having a control valve for controlling the amount of cooled protein beverage recycled back to the pasteurizer. A wedgewire-type filter having a supply pressure gauge was installed before the pasteurizer and a bag-type filter having a pressure sensor adapted for measuring pressure differentials across the bag-type filter was installed after the filler. Operators monitored readings from the pressure sensors and conducted visual inspections of the filters for signs of flocculation.

The control valve was operated so as to recycle about 20% of the cooled protein beverage. With a recycle rate of about 20%, the filters showed some signs of flocculation, but not enough to cause fouling. Consequently, the recycle rate was not decreased. It is believed that a recycle rate of approximately 50% or possibly higher may be attainable, depending on the minimization of factors such as fluid stagnation, pasteurization temperature, and hold time.

Although the foregoing specific details describe certain embodiments of this invention, persons reasonably skilled in the art will recognize that various changes may be made in the details of this invention without departing from the spirit and scope of the invention as defined in the appended claims and considering the doctrine of equivalents. Therefore, it should be understood that this invention is not to be limited to the specific details shown and described herein.

What is claimed is:

1. An apparatus for hot filling containers with protein beverage comprising:
a batch tank adapted for receiving a protein beverage;
a first heat exchanger in liquid communication with said batch tank, said first heat exchanger being adapted for heating said protein beverage to a temperature in the range of about 178° F. to about 200° F.;
a reservoir in liquid communication with said first heat exchanger, said reservoir being adapted for receiving said protein beverage and having an overflow stream of said protein beverage;
a filler in liquid communication with said reservoir, said filler being adapted for at least partially filling containers with said protein beverage received from said reservoir;
a second heat exchanger in liquid communication with said reservoir, said second heat exchanger being adapted for cooling said overflow stream to a temperature less than about 140° F.;
a rework tank in liquid communication with said second heat exchanger, said rework tank being adapted for receiving said overflow stream; and
a control valve in liquid communication with said rework tank and said first heat exchanger, said control valve being adapted for controlling a percentage of said overflow stream recycled to said first heat exchanger from said rework tank such that said protein beverage remains substantially free of floc.

2. The apparatus of claim 1 wherein said first heat exchanger is adapted for heating said protein beverage to a pasteurization temperature of about 189° F.

3. The apparatus of claim 1 wherein said second heat exchanger is adapted for cooling said overflow stream to a temperature of about 100° F.

4. The apparatus of claim 1 wherein said percentage of said overflow stream recycled is between about 10% and about 50%.

5. The apparatus of claim 1 further comprising:
an acid mixer in liquid communication with said batch tank, said acid mixer being adapted for mixing one or more acidic components of said protein beverage; and
a dry mixer in communication with said batch tank, said dry mixer being adapted for blending one or more dry components of said protein beverage.

6. The apparatus of claim 1 further comprising a trim cooler downstream from said reservoir and upstream from said second heat exchanger, said trim cooler being adapted for cooling said overflow stream before said overflow stream reaches said second heat exchanger.

7. The apparatus of claim 6 wherein said trim cooler comprises a double-tube type cooler.

8. The apparatus of claim 1 wherein said filler comprises:
one or more injectors in fluid communication with said reservoir;
wherein said one or more injectors are not in fluid communication with a circulating filler loop.

9. The apparatus of claim 8 wherein said one or more injectors comprise one or more calibrated electrode sensors adapted for dispensing a set amount of said protein beverage into said containers.

10. The apparatus of claim 1 further comprising at least one filter adapted for filtering floc from said protein beverage.

11. A method for manufacturing a protein beverage comprising:
creating a protein beverage in a batch tank;
heating said protein beverage using a first heat exchanger to a temperature in the range of about 178° F. to about 200° F.;
passing said protein beverage to a reservoir adapted for receiving said protein beverage and having an overflow stream of said protein beverage;
at least partially filling containers with said protein beverage received from said reservoir using a filler;
cooling said overflow stream to a temperature less than about 140° F. using a second heat exchanger;
temporarily storing said overflow stream in a rework tank; and
recycling at least a portion of said overflow stream to said first heat exchanger, said recycling being controlled such that said protein beverage remains substantially free of floc.

12. The method of claim 11 wherein said protein beverage is heated using said first heat exchanger to a temperature of about 189° F.

13. The method of claim 11 wherein said overflow stream is cooled using said second heat exchanger to a temperature of about 100° F.

14. The method of claim 11 wherein said recycling comprises recycling between about 10% and about 50% of said overflow stream.

15. The method of claim 11 further comprising:
admixing one or more acidic components of said protein beverage in a separate acid mixer; and
admixing one or more dry components of said protein beverage in a separate dry mixer.

16. The method of claim 11 further comprising cooling said overflow stream using a trim cooler downstream from said reservoir and upstream from said second heat exchanger, said trim cooler being adapted for cooling said overflow stream before said overflow stream reaches said second heat exchanger.

17. The method of claim 11 wherein said filler comprises:
one or more injectors in fluid communication with said reservoir;
wherein said one or more injectors are not in fluid communication with a circulating filler loop.

18. The method of claim 17 wherein said one or more injectors comprise one or more calibrated electrode sensors adapted for dispensing a set amount of said protein beverage.

19. The method of claim 11 further comprising filtering floc from said protein beverage.

20. The method of claim 11 wherein said protein beverage comprises a sports drink having a protein content of about 9 g per 591 mL.

21. A method for manufacturing a protein beverage comprising:
creating a protein beverage in a batch tank;
heating said protein beverage using a heat exchanger to a pasteurizing temperature sufficient to pasteurize said protein beverage;
passing said protein beverage to a reservoir, said reservoir having a main stream of said protein beverage and an overflow stream of said protein beverage;
at least partially filling one or more containers with said main stream;
cooling said overflow stream to a temperature below said pasteurizing temperature;
temporarily storing at least a portion of said overflow stream in a rework tank; and
recycling at least a portion of said overflow stream from said rework tank to said heat exchanger, said recycling being controlled such that said protein beverage remains substantially free of floc.

22. The method of claim 21 wherein said pasteurizing temperature is in the range of about 178° F. to about 200° F.

23. The method of claim 21 wherein said recycling comprises recycling between about 10% and about 50% of said overflow stream from said rework tank.

24. The method of claim 21 further comprising:
monitoring said protein beverage for the presence of floc;
increasing said recycling if said protein beverage remains substantially free of floc; and
decreasing said recycling if said protein beverage contains a specified amount of floc.
